(19) United States
(12) Patent Application Publication
(10) Pub. No.: US 2025/0305566 A1
(43) Pub. Date: Oct. 2, 2025

(54) END RECIRCULATOR FOR A BALL SCREW MECHANISM

(71) Applicant: NTN EUROPE, Annecy (FR)

(72) Inventor: Julien BERTHIER, Saint-Jorioz (FR)

(73) Assignee: NTN EUROPE, Annecy (FR)

(21) Appl. No.: 19/086,038

(22) Filed: Mar. 20, 2025

(30) Foreign Application Priority Data
Mar. 28, 2024 (FR) FR2403161

(51) Int. Cl. F16H 25/22; F16H 25/24

(52) U.S. Cl. CPC F16H 25/2219; F16H 25/2418

(57) ABSTRACT

The invention relates to a recirculator for a nut of a ball screw mechanism, comprising an annular body having a reference axis intended to be aligned with a helix axis of the nut, the annular body comprising a bearing surface configured to bear against a nut of the ball screw mechanism in a bearing direction having an axial component parallel to the reference axis, and a guide structure configured to guide balls in a recirculation path opening at a first guide end into a recirculation channel of the nut and at a second guide end onto a raceway defined by a thread of the nut, characterized in that the bearing surface is at least partially located in a section plane intersecting the recirculation path and perpendicular to the reference axis.

### CROSS-REFERENCE TO RELATED APPLICATIONS

This application claims the benefit of priority under 35 U.S.C. 119 from French Patent Application No. FR2403161, filed Mar. 28, 2024; the disclosure of which is incorporated herein by reference in its entirety.

### TECHNICAL FIELD OF THE INVENTION

The invention relates to the technical field of ball screws, and more particularly to ball screw recirculators with external recirculation.

### PRIOR ART

Document CN 217481881 presents a ball screw mechanism with external ball recirculation by means of two end recirculators positioned at both ends of the nut, and the balls of which are connected by a recirculation channel parallel to the screw axis. In addition to their ability to redirect balls as they recirculate through a recirculation channel, the end recirculators disclosed herein have the characteristic of retaining grease inside the annular space between the nut and the screw.

One of the disadvantages of such end recirculators is the axial space they take up, since the two functions of ball guiding and grease retention are performed by zones that are axially distant from one another. These recirculators can therefore only be used in ball screw mechanisms whose applications do not require extensive optimization of space requirements.

### DISCLOSURE OF THE INVENTION

The purpose of the invention is to overcome the disadvantages of the prior art and to propose a compact and simple solution for recirculating a ball screw mechanism.

According to a first aspect of the invention, a recirculator is proposed for a nut of a ball screw mechanism, the recirculator comprising an annular body about a reference axis of the recirculator intended to be aligned with a helix axis of the nut, the annular body comprising a bearing surface configured to bear against a nut of the ball screw mechanism in a bearing direction having an axial component parallel to the reference axis, and a guide structure configured to guide balls in a recirculation path opening at a first guide end into a recirculation channel of the nut and at a second guide end onto a raceway defined by a thread of the nut, characterized in that the bearing surface is at least partially located in a section plane intersecting the recirculation path and perpendicular to the reference axis.

The recirculator provides a large contact and bearing surface with the nut in a small volume, ensuring a good seal between the recirculator and the nut, and guiding of the balls of the ball screw mechanism.

According to one embodiment, the bearing surface is flat, making the part more compact and simplifying its manufacture. Alternatively, a truncated cone-shaped bearing surface is possible.

According to one embodiment, the bearing surface extends over an angular sector about the reference axis, which does not intersect the recirculation path. This thus distributes the bearing and guiding functions of the balls about the reference axis. Preferably, the angular sector has an apex angle greater than π/2 radians, preferably greater than 3π/4 radians, and less than 3π/2 radians, preferably less than 5π/4 radians, for example 7π/6 radians.

According to one embodiment, the guide structure projects radially outwards from the annular body.

According to one embodiment, the first guide end of the guide structure protrudes, in particular axially, with respect to the annular body, to create a curvilinear recirculation path whose first guide end protrudes axially from the annular body of the recirculator, so as to open into the recirculation channel of the nut.

According to one embodiment, the second guide end of the guide structure extends on both sides of the section plane.

According to one embodiment, the second guide end of the guide structure is formed by a scoop. Preferably, the scoop projects in a direction configured to be tangent to a raceway of the nut. In this way, the recirculator, via the scoop, enables balls to be recirculated in a fluid manner, in order to achieve a smooth, shock-free transition between the path defined by the raceway of the nut and the recirculation path, or a loss of efficiency.

According to one embodiment, the recirculation path at the first guide end is perpendicular to the bearing plane.

According to one embodiment, the annular body comprises a sealing lip extending radially inwards from the annular body of the recirculator, preferably the sealing lip is helical in shape, more preferably the sealing lip makes at least ½ a helix turn, preferably at least ¾ of a helix turn. In this way, the sealing lip forms a counter-form to the raceway of the screw, thus limiting leakage of a lubricant, such as grease, which is necessary for the smooth operation of the ball screw mechanism.

According to one embodiment, the recirculator is a single-piece unit, preferably made of plastic. The materials can be traditional plastics, partially or totally recycled plastics, or totally or partially biobased. A metal finish is also possible, for example by machining or sintering. Preferably, the recirculator can be molded without undercuts, enabling molded manufacturing and reducing the costs associated with cycle time or the complexity of mold or tool making. However, other manufacturing methods are also possible, such as additive manufacturing. A design with varying material properties and/or multiple materials is also possible.

According to another aspect, the invention relates to a ball screw mechanism comprising a screw, having an inner helical raceway and a central axis; a nut, having an outer helical raceway and a recirculation channel; at least two balls arranged between the inner helical raceway of the ball screw and the outer helical raceway of the nut; at least one end recirculator arranged at one of the axial ends of the nut to ensure recirculation of the balls, the end recirculator comprising a bearing surface against the nut and a guide structure to maintain the balls in a defined recirculation path; remarkable in that the end recirculator is as described above.

According to one embodiment, the axial end has a receiving surface in contact with the bearing surface of the recirculator, the bearing surface of the recirculator and the receiving surface of the nut having complementary geometries, so that the recirculator can be connected to the nut and form a homogeneous assembly.

According to one embodiment, the axial end comprises an annular skirt projecting axially from the receiving surface, the annular skirt and the receiving surface delimiting a volume in which the annular body of the recirculator is at least partially, and preferably totally, housed, enabling the recirculator to be inserted axially into the nut, protected by the latter, and improving the compactness and connection of the assembly formed by the nut and the recirculator.

According to one embodiment, the annular axial end has a radial notch in continuity with the recirculation channel, so as to accommodate the guide structure in a guide zone when the guide structure is in the usage position, and to have no protruding element with respect to the outer surface of the nut, thus ruling out the risk of snagging during handling or loss of radial compactness.

According to one embodiment, the notch forms a receiving zone forming at least one guide face for gentle recirculation of the beads between the recirculation channel and the recirculator.

Naturally, the ball screw mechanism can be equipped with two recirculators according to the first aspect of the invention, located at the two axial ends of the nut.

According to a particularly advantageous embodiment, the end recirculator has one or more guide faces facing one or more guide faces of the nut to delimit the recirculation path between the two ends. Using the end recirculator and the nut to define the recirculation path contributes to a more compact mechanism.

### BRIEF DESCRIPTION OF THE FIGURES

Other features and advantages of the invention will emerge on reading the following disclosure, with reference to the appended figures.

FIG. 1 shows a ball screw mechanism comprising a screw, a nut and two end recirculators.

FIG. 2 shows an isometric perspective view of the nut.

FIG. 3A shows an isometric perspective view of the end recirculator.

FIG. 3B shows a bottom view of the end recirculator.

FIG. 3C shows a front view of the end recirculator.

FIG. 3D shows a rear view of the end recirculator.

FIG. 3E shows a top view of the end recirculator.

FIG. 4 shows an axial section of the ball screw mechanism.

For greater clarity, identical or similar elements are identified by identical reference signs in all of the Figures.

### DETAILED DESCRIPTION OF EMBODIMENTS

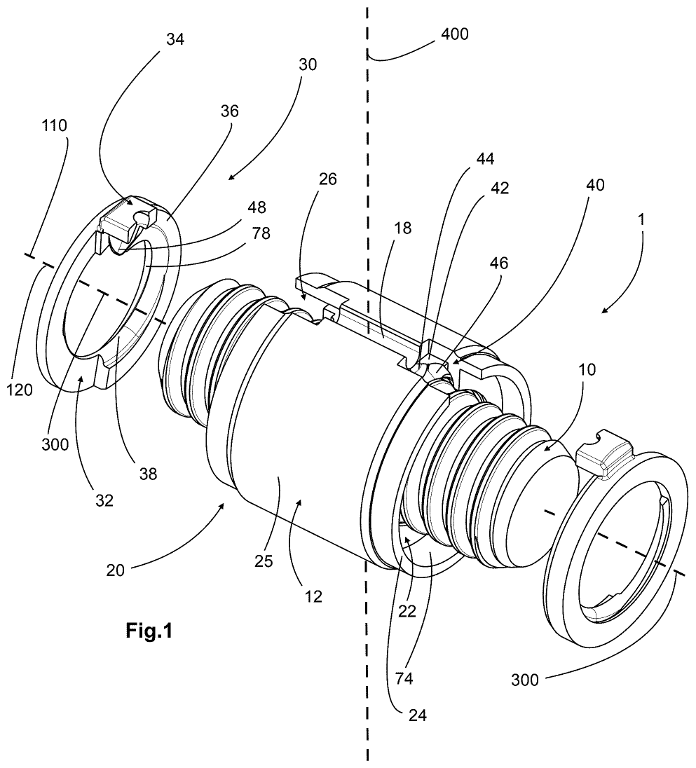

FIG. 1 shows a ball screw mechanism 1 comprising two threaded components, namely a screw 10 and a nut 12, balls and two end recirculators 30, all aligned on a reference axis 100 of the ball screw mechanism 1, which is aligned with a reference axis 110 of the screw 10, a reference axis 120 of the nut 12 and a reference axis 300 of each of the two end recirculators 30.

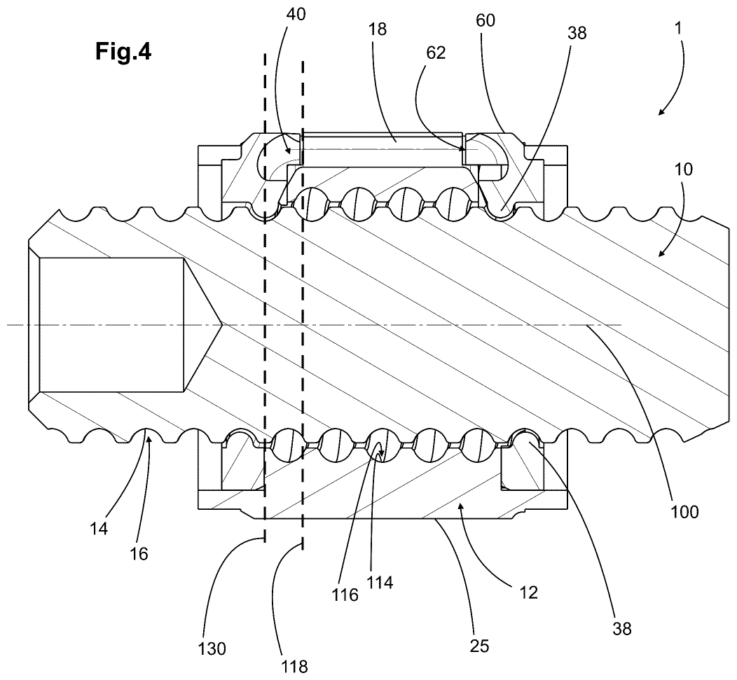

The ball screw mechanism 1, as shown in FIGS. 1 and 4, without the balls, has an axis of symmetry 400 perpendicular to the axis 100, so that the description of the recirculator 30 at one end of the nut 12 will be transposable to the recirculator 30 at the opposite end of the nut. However, this symmetry is simply an option and is not limitative.

The screw 10 is preferably metal, for example steel, and has a screw thread 14 which forms an inner helical raceway 16 about the reference axis 110 of the screw 10, the inner helical raceway 16 facing radially away from the reference axis 110.

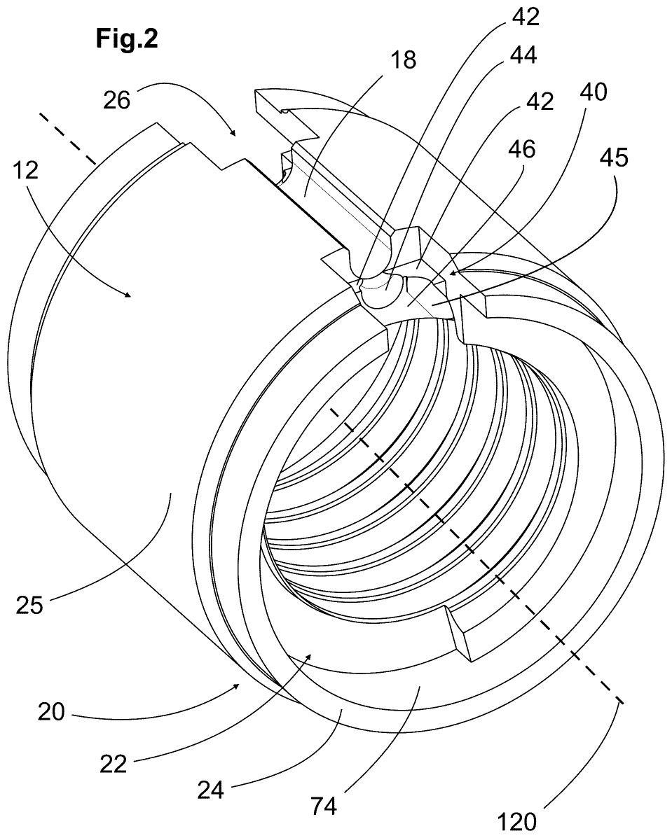

The nut 12, shown in detail in FIGS. 2 and 4, is preferably metal, for example steel, and is generally cylindrical in shape. The nut 12 has a nut thread 114 which forms an outer helical raceway 116 about the reference axis 120, facing radially inwards, and an outer surface 25 facing radially outwards. The outer surface 25 is cylindrical and axially traversed by a recirculation channel 18. The recirculation channel 18 is located radially at a distance from the raceway 116 of the nut 12 and preferably spans several turns thereof. In this embodiment, the recirculation channel 18 is of the open type, that is, it forms a slot on the outer surface 25 of the nut 12, but this configuration is optional, and a recirculation channel 18 that is totally or partially closed at its outer radial periphery may alternatively be provided, depending on the design requirements.

The nut 12 further has two axial ends 20 opposite two opposite axial ends of the recirculation channel 18. Each of the axial ends 20 is annular and has a receiving surface 22 and an annular skirt 24, projecting axially outwards from the receiving surface 22. The skirt 24 has a diameter slightly smaller than the diameter of the outer surface 25, which can be used, for example, to fasten a flange for a component secured to the nut 12, or to fasten a bellows seal. The skirt 24 has an inner annular face 74 facing radially toward the reference axis 120. The receiving surface 22 and the skirt 24 are configured to receive the end recirculator 30 and delimit a housing volume for the end recirculator 30. Each axial end 20 has a radial notch 26, bounded by the end plane 118 of the recirculation channel 18, this notch 26 splitting the skirt 24 so that it only forms an arc of a cylinder. The notch 26 creates a receiving zone 40, the shape of which corresponds to a counter-shape of a guide structure 34 of the end recirculator 30, which will be described below.

In another embodiment, the recirculation channel 18 is closed, that is, it is integrated into the nut 12. If necessary, the notch 26 does not split the entire skirt 24 so that said skirt 24 is annular.

The receiving zone 40, formed in the nut 12 by the notch 26, comprises two support flats 42 on both sides of a first guide face 44 of the nut 12 connected to the recirculation channel 18, as well as a second guide face 45 and a scoop support 46.

The receiving surface 22 forms a plane annular arc about the reference axis 120, extending from the notch 26 over an angular sector of the apex angle greater than π/2 radian, preferably greater than 3π/4, and less than 3π/2, preferably less than 5π/4, for example 7π/6, in a clockwise 210 or counterclockwise 220 direction so as to form a counter-form of a bearing surface 36 described subsequently.

The end recirculators 30 are preferably made of plastic, so as to be in one piece, while at the same time being able to be manufactured by molding without undercuts, thus reducing part manufacturing times and cutting costs. The plastic material can be a conventional plastic, a partially or fully recycled plastic and/or a fully or partially biobased plastic. However, if required, the end recirculators 30 can be made of other materials, such as metal, if necessary, with a machining and/or sintering step, and if necessary be composed of several parts. A multi-nature and/or multi-material design is also possible.

The two end recirculators 30 are identical and feature an annular body 32 and a guide structure 34, the guide structure 34 projecting radially outwards, and axially toward the nut 12, relative to the annular body 32.

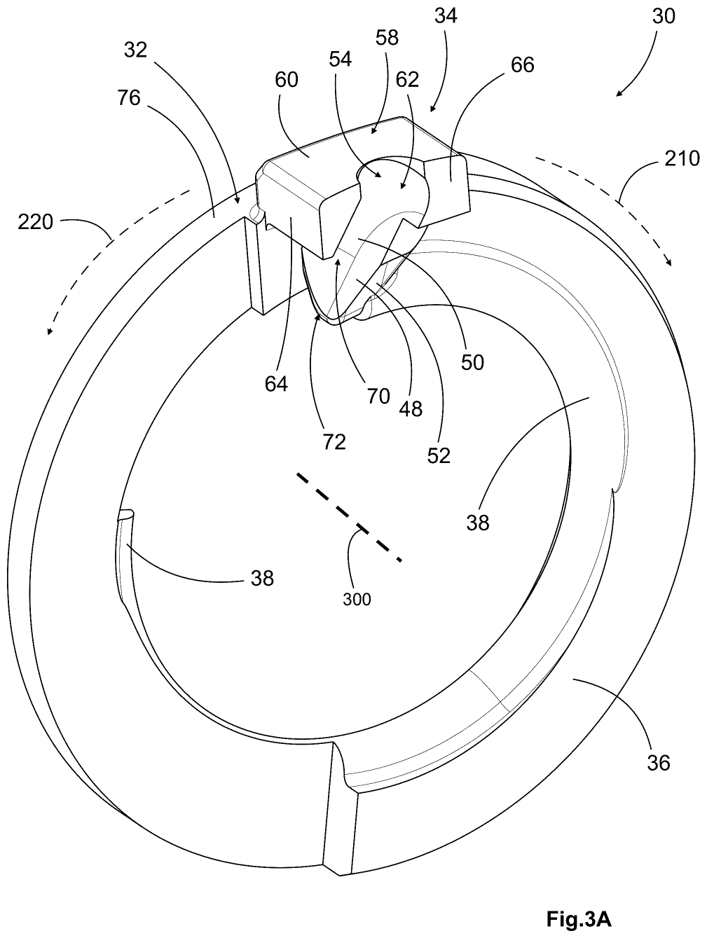

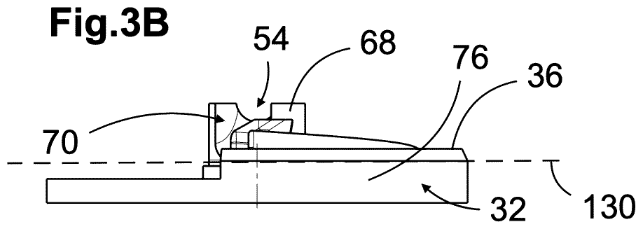

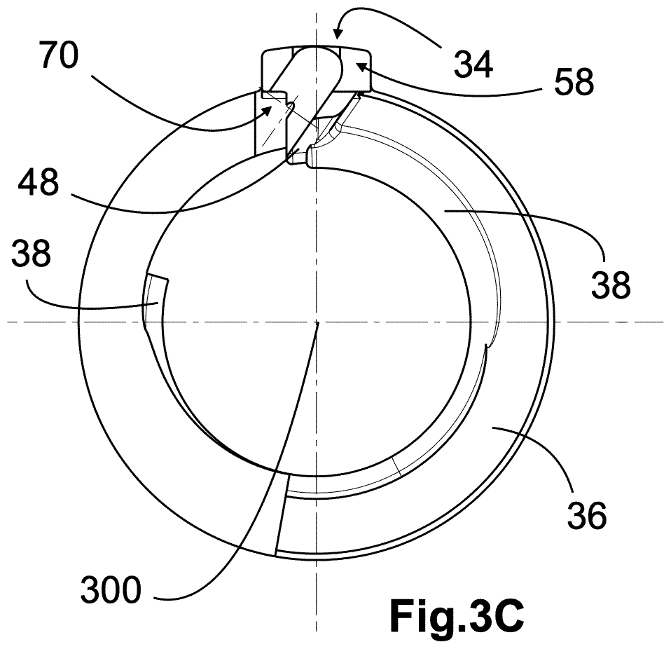

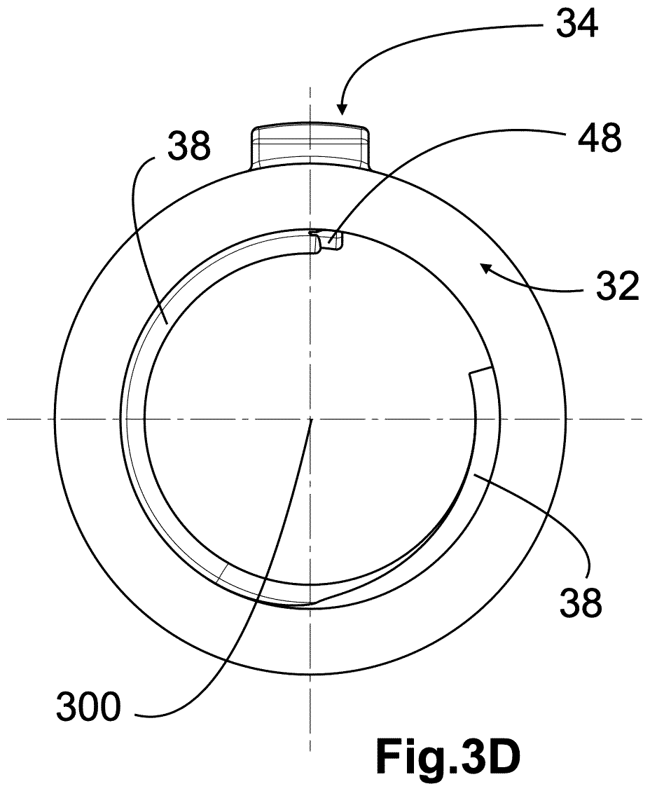

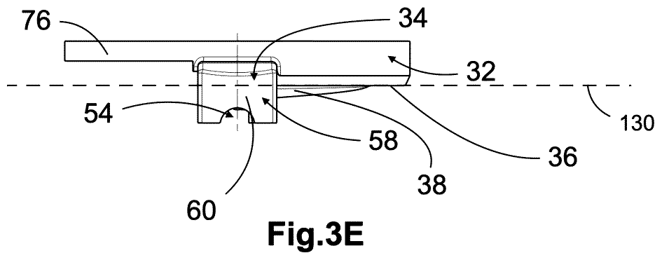

The annular body 32, shown in detail in FIGS. 3A, 3B, 3C, 3D and 3E, has an outer annular face 76 facing radially outwards and an inner annular face 78 facing radially toward the reference axis 300. Furthermore, the annular body 32 comprises a plane bearing surface 36 in a bearing plane 130 and is configured to bear against the nut 12, at the receiving surface 22, when the end recirculator 30 is in the usage position.

The bearing surface 36 is in the form of a flat annular arc extending over an angular sector about the reference axis 300, with an apex angle greater than π/2 radian, preferably greater than 3π/4, and less than 3π/2, preferably less than 5π/4, for example 7π/6, extending from the guide structure 34 in a clockwise direction 210. The annular body 32 further features a sealing lip 38 extending radially inwards from the annular body 32 of the end recirculator 30. The sealing lip 38 is arranged on the inner annular face 78 of the recirculator 30 and forms a counter-shape to the inner helical raceway 16, in particular of the homothetic type, without coming into contact with the screw 10.

The guide structure 34 has a positioning body 58 and a scoop 48 which form an open guide duct 70 for the balls along a curvilinear path between a first guide end 62, open to the recirculation channel 18, and a second guide end 72, open to the raceways 16, 116 of the screw 10 and nut 12.

The first guide end 62 projects axially with respect to the section plane 130, while the second guide end 72 projects “obliquely” between the raceways 16, 116 of the screw 10 and nut 12. Furthermore, the second guide end 72 is intersected by the section plane 130.

More specifically, the positioning body 58 has an outer wall 60, two side walls 64, two transverse walls 66 and an inner wall 68. The outer wall 60 is located radially outside the other walls, while the inner wall 68 is located radially inside the other walls. One of the two transverse walls 66 overlaps the annular body 32, while the other transverse wall, shown in FIG. 3A, projects axially with respect to the section plane 130 and forms the first guide end 62, designed to open onto the recirculation channel 18. The positioning body 58 has a guide notch 54 open to the outer wall 60 at the first guide end 62 when the recirculation channel 18 is, as in the present case, open.

The scoop 48 forms the second guide end 72 of the open guide duct 70 and is configured to open onto the raceways 16, 116 of the screw 10 and nut 12, and to fluidly redirect the balls from the recirculation channel 18 to the raceways 16, 116 of the screw 10 and nut 12 and vice versa. For this purpose, the scoop 48 is oriented radially and orthoradially, in order to guide the balls toward the recirculation channel 18 or the raceways 16, 116, with possibly a minimal axial component so that the ball guidance by the scoop 48 is tangent to the helical raceways 16, 116. The scoop 48 has a guide face 50, configured to orient the balls during recirculation thereof, and a rear face 52, arranged opposite the guide face 50. The guide face 50 is a groove whose profile may be, for example, circular-arc or ogive-shaped, defining a recirculation path between two ends 62, 72 of the groove. The scoop 48 is intersected by the bearing plane 130. Remarkably, the guide faces 44, 45 of the nut 12 face the guide face 50 of the recirculator, so that the recirculation path is delimited, over its entire length between the two ends 62, 72 of the groove, by the guide face 50 of the end recirculator 30 and the first and second guide faces 44, 45 of the nut 12.

The sealing lip 38 extends from the scoop 48, over the inner annular face 78 of the end recirculator 30, taking shape at the rear face 52 of the scoop 48 in the same clockwise direction of rotation 210 as the bearing surface 36, that is, clockwise 210, over at least ½ a helix turn, preferably at least ¾ of a helix turn, without making a complete helix turn. The sealing lip 38 is intersected by the bearing plane 130.

The guide structure 34 and the annular body 32 are respectively complementary to the receiving zone 40 and the receiving surface 22 of the nut 12.

The balls can be made of steel or ceramic, for example, and are sized and positioned to circulate in a closed circuit between the outer helical raceway 116 of the nut 12 and the inner helical raceway 16 of the screw 10, between the guide face 50 of each end recirculator 30 and the first and second recirculation faces 44, 45 of the nut 12 and in and the recirculation channel 18, preferably without separators between the balls.

During assembly, the end recirculators 30 are inserted axially into the nut 12, one end recirculator 30 at each of the two axial ends 20, making the ball screw mechanism 1 more compact. In the following description of the assembly, we will detail the positioning of a single end recirculator 30; this description naturally applies to the second end recirculator 30. The end recirculator 30 is forcibly inserted axially into the axial end 20, the annular body 32 being shrunk to the inner annular face 74, so as to be in the usage position when the bearing surface 36 of the end recirculator 30 abuts against the receiving surface 22. The bearing surface 36 is then in contact with the receiving surface 22, while the annular face 76 of the end recirculator 30 is in contact with the annular inner face 74 of the skirt 24. The sealing lip 38 extends the helical pattern of the nut 12 thread.

In addition, the guide structure 34 is housed in the receiving zone 40 and is in contact with the nut 12. More precisely, the inner wall 68 contacts and rests on the support flats 42, the two side walls 64 and one of the two transverse walls 66 are in contact with the nut 12, the scoop 48 rests in contact on the scoop support 46, and at the first guide end 62, the scoop 48 opens out in tangential contact on the second guide face 45 of the nut 12, which itself opens out on the first guide face 44 which opens out on the recirculation channel 18. The guide faces 44, 45 of the nut 12 allow a transition from the recirculation channel 18 to the scoop 48 of the end recirculator 30 and vice versa, enabling a smooth recirculation path between the recirculation channel 18 and the end recirculator 30.

The screw 10 can be screwed into the assembly formed by the nut 12 and the two end recirculators 30. The sealing lip 38 penetrates the inner helical raceway 16, without making contact, and minimizes the leakage of lubricant into the ball screw mechanism 1, for example, grease. The balls can then be inserted into the ball screw mechanism 1 one by one through the recirculation channel 18. The balls run in the helical raceways 16, 116 through the end recirculators 30. The ball screw mechanism 1, shown in FIG. 4, is then closed by a sleeve shrunk onto the outer surface 25 of nut 12, thus closing the recirculation channel 18.

The examples shown in the figures and discussed above are provided for illustrative purposes only. Other embodiments can be envisaged, in particular by combining the features of the various embodiments illustrated.

For example, the end recirculator 30 may have at the bearing face 36, a lug comprising a chamfer and a lip, enabling it to snap into a corresponding counter-form located in the receiving face 22 of the nut 12.

1. A recirculator for a nut of a ball screw mechanism, comprising:
an annular body about a reference axis of the recirculator intended to be aligned with a helix axis of the nut, the annular body comprising a bearing surface configured to bear against the nut of the ball screw mechanism in a bearing direction having an axial component parallel to the reference axis, and a guide structure configured to guide balls in a recirculation path opening at a first guide end into a recirculation channel of the nut and at a second guide end onto a raceway defined by a thread of the nut, wherein the bearing surface is at least partially located in a section plane intersecting the recirculation path and perpendicular to the reference axis and the second guide end of the guide structure extends on both sides of the section plane.

2. The recirculator of claim 1, wherein the bearing surface is flat.

3. The recirculator of claim 1, wherein the bearing surface extends over an angular sector about the reference axis, which does not intersect the recirculation path.

4. The recirculator of claim 3, wherein the angular sector has an apex angle greater than π/2 radians and less than 3π/2 radians.

5. The recirculator of claim 1, wherein the guide structure projects radially outwards from the annular body.

6. The recirculator of claim 1, wherein the first guide end of the guide structure projects axially with respect to the annular body.

7. The recirculator of claim 1, wherein the second guide end of the guide structure extends on both sides of the section plane.

8. The recirculator of claim 1, wherein the second guide end of the guide structure is formed by a scoop.

9. The recirculator of claim 1, wherein the second guide end of the guide structure is formed by a scoop, which projects in a direction configured to be tangent to a raceway of the nut.

10. The recirculator of claim 1, wherein the recirculation path at the first guide end is perpendicular to a bearing plane.

11. A recirculator for a nut of a ball screw mechanism, comprising:
an annular body about a reference axis of the recirculator intended to be aligned with a helix axis of the nut, the annular body comprising a bearing surface configured to bear against the nut of the ball screw mechanism in a bearing direction having an axial component parallel to the reference axis, and a guide structure configured to guide balls in a recirculation path opening at a first guide end into a recirculation channel of the nut and at a second guide end onto a raceway defined by a thread of the nut, wherein the bearing surface is at least partially located in a section plane intersecting the recirculation path and perpendicular to the reference axis, and the annular body comprises a sealing lip extending radially inwards from the annular body of the recirculator.

12. The recirculator of claim 11, wherein the sealing lip is helical.

13. The recirculator of claim 11, wherein the sealing lip performs at least a ½ helix turn.

14. The recirculator of claim 11, wherein the recirculator is in one piece.

15. The recirculator of claim 11, wherein the recirculator is moldable without undercuts.

16. A ball screw mechanism comprising:
a screw, with an inner helical raceway and a central axis;
a nut with an external helical raceway and a recirculation channel;
at least two balls arranged between the inner helical raceway of the ball screw and the external helical raceway of the nut;
at least end recirculator arranged at one axial end of the nut for recirculating the balls, the recirculator comprising an annular body about a reference axis of the recirculator aligned with a helix axis of the nut, the annular body comprising a bearing surface, which bears against the nut of the ball screw mechanism in a bearing direction having an axial component parallel to the reference axis, and a guide structure configured to guide the balls in a recirculation path opening at a first guide end into the recirculation channel of the nut and at a second guide end onto the external raceway, wherein the bearing surface is at least partially located in a section plane intersecting the recirculation path and perpendicular to the reference axis and the second guide end of the guide structure extends on both sides of the section plane.

17. The ball screw mechanism of claim 16, wherein the axial end has a receiving surface in contact with the bearing surface of the recirculator, the bearing surface of the recirculator and the receiving surface of the nut having complementary geometries.

18. The ball screw mechanism of claim 17, wherein the axial end comprises an annular skirt projecting axially from the receiving surface, the annular skirt and the receiving surface delimiting a volume wherein the annular body of the recirculator is at least partially housed.

19. The ball screw mechanism of claim 18, wherein the annular skirt has a radial notch in continuity with the recirculation channel.

20. The ball screw mechanism of claim 16, wherein the recirculator has one or more guide faces facing one or more guide faces of the nut to delimit the recirculation path between the two ends.
